(19) United States
(12) Patent Application Publication
(10) Pub. No.: US 2025/0039775 A1
(43) Pub. Date: Jan. 30, 2025

(54) DATA MINIMIZATION IN NETWORK FUNCTION TO NETWORK FUNCTION COMMUNICATION

(71) Applicant: Nokia Technologies Oy, Espoo (FI)

(72) Inventors: Harish MURALIDHARA, Bangalore (IN); Saurabh KHARE, Bangalore (IN)

(21) Appl. No.: 18/757,794

(22) Filed: Jun. 28, 2024

(30) Foreign Application Priority Data
Jul. 28, 2023 (IN) 202311050894

(51) Int. Cl. H04W 48/16; H04W 12/043; H04W 12/069; H04W 60/04

(52) U.S. Cl. CPC H04W 48/16; H04W 12/043; H04W 12/069; H04W 60/04

(57) ABSTRACT

There are provided measures for data minimization in network function to network function communication. Such measures exemplarily comprise, at a first network function entity configured for communication with a second network function entity, transmitting, towards a network repository function entity, a discovery message, receiving, from said network repository function entity, a response message comprising a first encryption key of said second network function entity, encrypting data, using the first encryption key, as encrypted data, and transmitting, towards said second network function entity, a service request with said encrypted data.

### FIELD

Various example embodiments relate to data minimization in network function to network function communication. More specifically, various example embodiments exemplarily relate to measures (including methods, apparatuses and computer program products) for realizing data minimization in network function to network function communication.

### BACKGROUND

The present specification generally relates to data security and data minimization. 3^{rd} Generation Partnership (3GPP) defines 5^{th} Generation (5G) core network functions (NF) and relevant application programming interfaces (API) each NF has to provide so that communication across NFs via service-based interfaces (SBI) is effective.

3GPP also has defined an OAuth framework so that one can be sure that NFs are authorized to take the service and to process the message/information.

3GPP further defines transport layer security (TLS) over Hypertext Transfer Protocol Version 2 (HTTP/2) so that the messages are encrypted and transferred securely to escape eavesdropping.

3GPP standards also make sure that NFs process a minimal set of data that they are intended to, by defining the JavaScript Object Notation (JSON) structure of message content.
To provide flexibility, on certain interfaces, to send vendor specific information, 3GPP has defined vendor-specific attributes (VSA) in their messages. Such vendor specific attributes include, for example, “VendorSpecificFeature” (in TS 29.510) and “OperatorSpecificDataContainer” (in TS 29.505).

When defining a means for sending vendor-specific information between two NFs, 3GPP standards break a critical privacy principle of data minimization, i.e., to avoid NFs from excessive collection and processing of data other than what is defined in their standards. This particular holds true for NFs for which the vendor-specific information sent between two NFs are not intended.

While vendor-specific information serve just as an example, in more general terms, when defining a means for sending an arbitrary information element (IE) between two NFs, the data minimization principle/requirement may not be satisfied at least for NFs for which the respective IE sent between two NFs is not intended.

Hence, the problem arises that the data minimization principle/requirement may be weakened, potentially leading to weakening of data security.

Hence, there is a need to provide for data minimization in network function to network function communication.

### SUMMARY

Various example embodiments aim at addressing at least part of the above issues and/or problems and drawbacks.

Various aspects of example embodiments are set out in the appended claims.

According to an exemplary aspect, there is provided an apparatus of a first network function entity configured for communication with a second network function entity, the apparatus comprising transmitting circuitry configured to transmit, towards a network repository function entity, a discovery message, receiving circuitry configured to receive, from said network repository function entity, a response message comprising a first encryption key of said second network function entity, encrypting circuitry configured to encrypt data, using the first encryption key, as encrypted data, and transmitting circuitry configured to transmit, towards said second network function entity, a service request with said encrypted data.

According to an exemplary aspect, there is provided an apparatus of a second network function entity configured for communication with a first network function entity, the apparatus comprising generating circuitry configured to generate a registration message comprising a first encryption key, transmitting circuitry configured to transmit, towards a network repository function entity, said registration message, receiving circuitry configured to receive, from an intermediate network entity, a service request with encrypted data encrypted using the first encryption key, and decrypting circuitry configured to decrypt said encrypted data using a first decryption key.

According to an exemplary aspect, there is provided an apparatus, the apparatus comprising receiving circuitry configured to receive, from a second network function entity, a registration message comprising a first encryption key, and storing circuitry configured to store said first encryption key of said second network function entity.

According to an exemplary aspect, there is provided an apparatus of a first network function entity configured for communication with a second network function entity, the apparatus comprising at least one processor, at least one memory including computer program code, and at least one interface configured for communication with at least another apparatus, the at least one processor, with the at least one memory and the computer program code, being configured to cause the apparatus to perform transmitting, towards a network repository function entity, a discovery message, receiving, from said network repository function entity, a response message comprising a first encryption key of said second network function entity, encrypting data, using the first encryption key, as encrypted data, and transmitting, towards said second network function entity, a service request with said encrypted data.

According to an exemplary aspect, there is provided an apparatus of a second network function entity configured for communication with a first network function entity, the apparatus comprising at least one processor, at least one memory including computer program code, and at least one interface configured for communication with at least another apparatus, the at least one processor, with the at least one memory and the computer program code, being configured to cause the apparatus to perform generating a registration message comprising a first encryption key, transmitting, towards a network repository function entity, said registration message, receiving, from an intermediate network entity, a service request with encrypted data encrypted using the first encryption key, and decrypting said encrypted data using a first decryption key.

According to an exemplary aspect, there is provided an apparatus, the apparatus comprising at least one processor, at least one memory including computer program code, and at least one interface configured for communication with at least another apparatus, the at least one processor, with the at least one memory and the computer program code, being configured to cause the apparatus to perform receiving, from a second network function entity, a registration message comprising a first encryption key, and storing said first encryption key of said second network function entity.

According to an exemplary aspect, there is provided a method of a first network function entity configured for communication with a second network function entity, the method comprising transmitting, towards a network repository function entity, a discovery message, receiving, from said network repository function entity, a response message comprising a first encryption key of said second network function entity, encrypting data, using the first encryption key, as encrypted data, and transmitting, towards said second network function entity, a service request with said encrypted data.

According to an exemplary aspect, there is provided a method of a second network function entity configured for communication with a first network function entity, the method comprising generating a registration message comprising a first encryption key, transmitting, towards a network repository function entity, said registration message, receiving, from an intermediate network entity, a service request with encrypted data encrypted using the first encryption key, and decrypting said encrypted data using a first decryption key.

According to an exemplary aspect, there is provided a method, the method comprising receiving, from a second network function entity, a registration message comprising a first encryption key, and storing said first encryption key of said second network function entity.

According to an exemplary aspect, there is provided a computer program product comprising computer-executable computer program code which, when the program is run on a computer (e.g. a computer of an apparatus according to any one of the aforementioned apparatus-related exemplary aspects of the present disclosure), is configured to cause the computer to carry out the method according to any one of the aforementioned method-related exemplary aspects of the present disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient improvement in relation to data minimization to thereby solve at least part of the problems and drawbacks identified in relation to the prior art.

By way of example embodiments, there is provided data minimization in network function to network function communication. More specifically, by way of example embodiments, there are provided measures and mechanisms for realizing data minimization in network function to network function communication.

Thus, improvement is achieved by methods, apparatuses and computer program products enabling/realizing data minimization in network function to network function communication.

### BRIEF DESCRIPTION OF THE DRAWINGS

In the following, the present disclosure will be described in greater detail by way of non-limiting examples with reference to the accompanying drawings, in which

FIG. 1 is a block diagram illustrating an apparatus according to example embodiments,

FIG. 2 is a block diagram illustrating an apparatus according to example embodiments,

FIG. 3 is a block diagram illustrating an apparatus according to example embodiments,

FIG. 4 is a block diagram illustrating an apparatus according to example embodiments,

FIG. 5 is a block diagram illustrating an apparatus according to example embodiments,

FIG. 6 is a schematic diagram of a procedure according to example embodiments,

FIG. 7 is a schematic diagram of a procedure according to example embodiments,

FIG. 8 is a schematic diagram of a procedure according to example embodiments,

FIG. 9 shows a schematic diagram of signaling sequences,

FIG. 10 shows a schematic diagram of signaling sequences,

FIG. 11 shows a schematic diagram of signaling sequences according to example embodiments,

FIG. 12 shows a schematic diagram of signaling sequences according to example embodiments,

FIG. 13 shows a schematic diagram of signaling sequences according to example embodiments, and

FIG. 14 is a block diagram alternatively illustrating apparatuses according to example embodiments.

### DETAILED DESCRIPTION

The present disclosure is described herein with reference to particular non-limiting examples and to what are presently considered to be conceivable embodiments. A person skilled in the art will appreciate that the disclosure is by no means limited to these examples, and may be more broadly applied.

It is to be noted that the following description of the present disclosure and its embodiments mainly refers to specifications being used as non-limiting examples for certain exemplary network configurations and deployments. Namely, the present disclosure and its embodiments are mainly described in relation to 3GPP specifications being used as non-limiting examples for certain exemplary network configurations and deployments. As such, the description of example embodiments given herein specifically refers to terminology which is directly related thereto. Such terminology is only used in the context of the presented non-limiting examples, and does naturally not limit the disclosure in any way. Rather, any other communication or communication related system deployment, etc. may also be utilized as long as compliant with the features described herein.

Hereinafter, various embodiments and implementations of the present disclosure and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

As used herein, “at least one of the following:” and “at least one of” and similar wording, where the list of two or more elements are joined by “and” or “or”, mean at least any one of the elements, or at least any two or more of the elements, or at least all the elements.

According to example embodiments, in general terms, there are provided measures and mechanisms for (enabling/realizing) data minimization in network function to network function communication.

As mentioned above, when defining a means for sending an arbitrary IE between two NFs, the data minimization principle/requirement may not be satisfied at least for NFs for which the respective IE sent between two NFs is not intended. Namely, 3GPP has not enforced a framework to achieve the privacy principles of data minimization and data protection, namely to avoid NFs from excessive collection and processing of data other than what is defined in their standards when vendor-specific information (could be privacy data)—or, as mentioned above, more general, an arbitrary IE—is in a message, particular, in a message transmitted via the NFs.

In addition, privacy protection rules that are applied on an NF-sender side (e.g. an NF consumer) and on an NF-receiver side (e.g. an NF-producer) is not strictly enforced in an NF-intermediate entity (e.g., policies are not configured properly in NF-intermediate or its different-vendor solution). Generally, any network function in 3GPP core network can become NF consumer or NF producer. NF becomes an NF consumer when it requests the service/data from another NF. In this case, the other NF who provides the service/data becomes an NF producer.

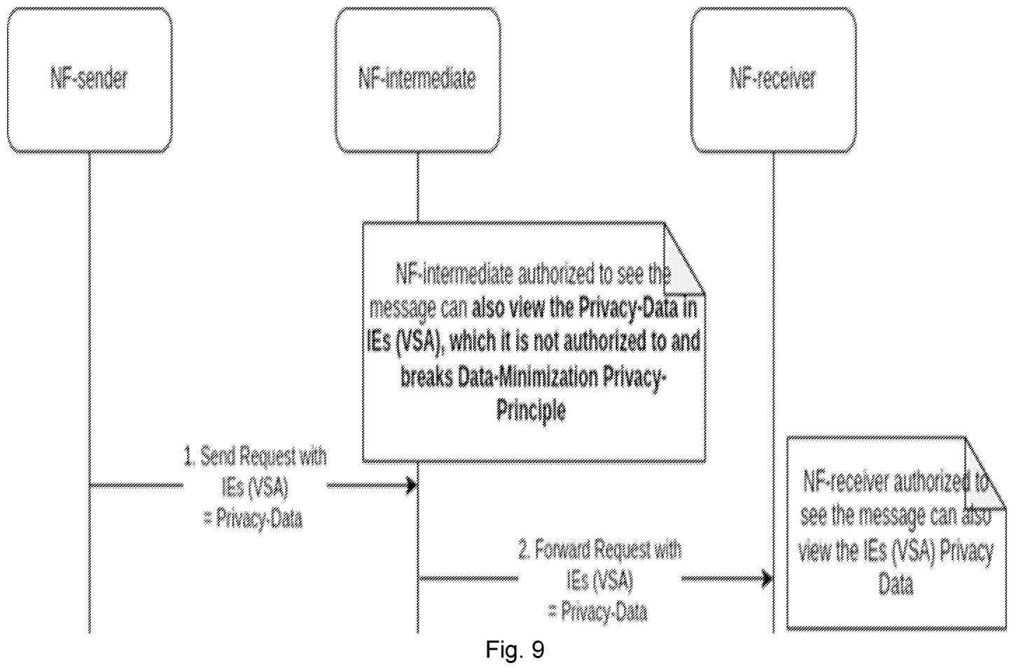

FIG. 9 shows a schematic diagram of signaling sequences, and in particular illustrates the above-discussed issues in a generic manner.

If, for example, an NF-sender (e.g. an NF consumer) sends a message to an NF-receiver (e.g. an NF-producer) via an NF-intermediate over an SBI interface, the NF-intermediate (also authorized to view the content of the message) can process the message, which could be termed as a necessity as per standards.

If the NF-sender (e.g. an NF consumer) wants to send some proprietary/personal information to the NF-receiver (e.g. an NF-producer), the NF-sender (e.g. an NF consumer) can do so by sending the proprietary/personal information via VSAs.

Whole only the NF-sender (e.g. an NF consumer) and the NF-receiver (e.g. an NF-producer) are (intentionally) approved to process this personal data (i.e., proprietary/personal information), this data is also authorized to be processed by NF-intermediate.

Namely, vendors (e.g. the NF-sender (NF consumer)) cannot mandate the NF-intermediate to stop processing this proprietary/personal information in the VSAs. Thus, there is a risk involved in privacy assurance and engineering process (PEAP). The risk is concerning data-minimization, and up to some extent reduce data linkability, too. Linkability is when it is possible to link all of the data (events or records or logs) that belong to the same data subject together, or to link all the data to point to an individual.

As the TLS is hop-by-hop only, this measure does not protect the data at intermediate NFs. In other words, an intermediate NF may have full access to the data.

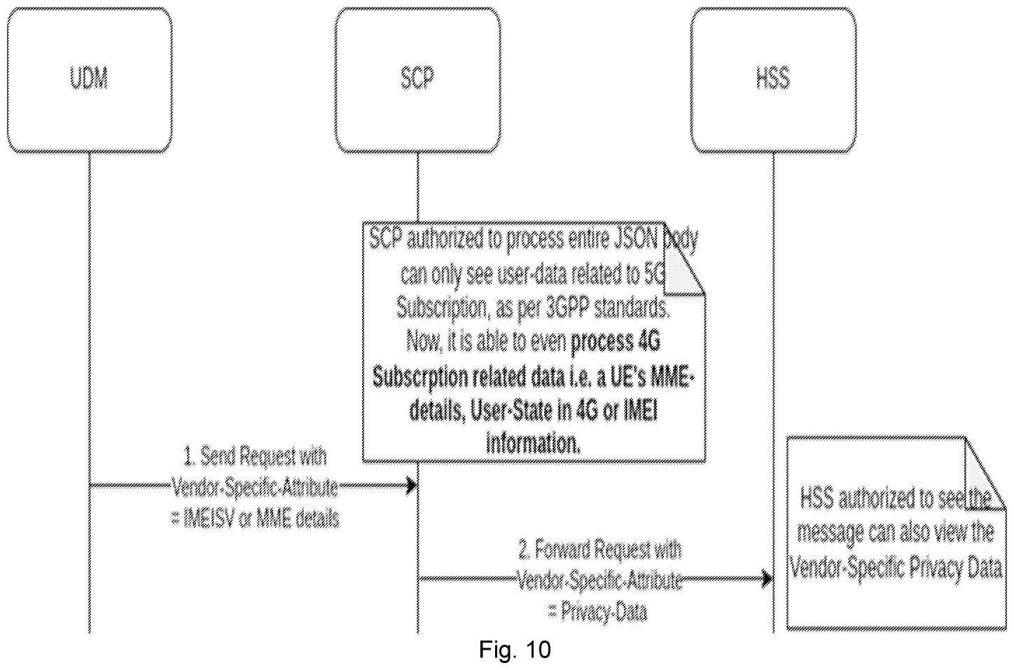

FIG. 10 shows a schematic diagram of signaling sequences, and in particular illustrates the above-discussed issues in a specific manner.

With reference to FIG. 10, a real use-case in a 3GPP scenario is described which demands improvement as proposed herein.

As illustrated in FIG. 10, an operator may be using a home subscriber server (HSS) of a first vendor and a unified data manager (UDM) of the (same) first vendor. Hence, the HSS and the UDM are in legal-terms to process subscriber data both in 4^{th} Generation (4G) and in 5G.

For example for optimizing a flow, the UDM reads even 4G subscription privacy data (like International Mobile Equipment Identity (IMEI), user-state information, etc.) along with 5G data before sending the same to HSS.

This data is also processed by the intermediate NF, which is a service communication proxy (SCP) in the present example case.

In the present example, the SCP is from a different second vendor and is in legal terms to process the messages/logs.

As per 3GPP standards, this flow defines and assumes that the SCP is capable enough to process/view only 5G subscription data. This assumption is not true, as the SCP is actually able to view also the 4G data the UDM is sending (to the HSS).

Consequently, the SCP can analyze the logs/packets that the SCP might write.

This fails the privacy principle of data-minimization at the SCP.

In addition, the SCP is now capable to link 4G and 5G data and hence to gather more personal data, which is also strongly opposed by most privacy regulatory bodies.

In addition to the above (i.e. that the intermediate NF accesses the full data), the NF-sender/consumer (i.e., UDM) has a privacy protection such that if any logs are written by the NF-sender/consumer (i.e., UDM), then the NF-sender/consumer (i.e., UDM) can cipher the data considering the privacy policy available in the NF-sender/consumer (i.e., UDM).

However, as full data is available at the intermediate NF (i.e., SCP) as well, which is not aware of the privacy rule, the intermediate NF (i.e. SCP) writes logs with clear text. As an example, it is assumed that the NF-sender/consumer (i.e., UDM) sends a message-X to the NF-receiver/producer (i.e., HSS) with e.g. an IMSI in a vendor-specific IE. As the NF-sender/consumer (i.e., UDM) and the NF-receiver/producer (i.e., HSS) are aware of the vendor-specific IE, they can apply privacy rules and cipher the IMSI while writing in logs. However, if the communication goes via the intermediate NF (i.e., SCP), the intermediate NF (i.e., SCP) writes logs with the IMSI in clear text.

The intermediate NF issue described above in particular with reference to FIG. 10 and in relation to the use-case involving an HSS and a UDM of a (same) first vendor and an SCP of a (different) second vendor may arise in any intermediate NF communication, for example:
any SCP communication,
network exposure function (NEF)→UDM→access and mobility management function (AMF) communication,
NEF→UDM→session management function (SMF) communication,
application function (AF)→NEF→AMF communication,
AF→NEF→UDM→AMF communication,
SEPP-plmn1→roaming hub→SEPP-plmn2 communication (SEPP: security edge protection proxy; PLMN: public land mobile network).

In view thereof, in brief, according to example embodiments, encryption of the IEs (or VSAs) containing some data (privacy data) by the NF-sender/consumer using an NF-receiver/producer's encryption key (e.g. a public key in case of asymmetric encryption, or a “general” key in case of symmetric encryption) and transmission of the encrypted IEs (or VSAs) to the NF-receiver/producer via intermediate NFs is provided.

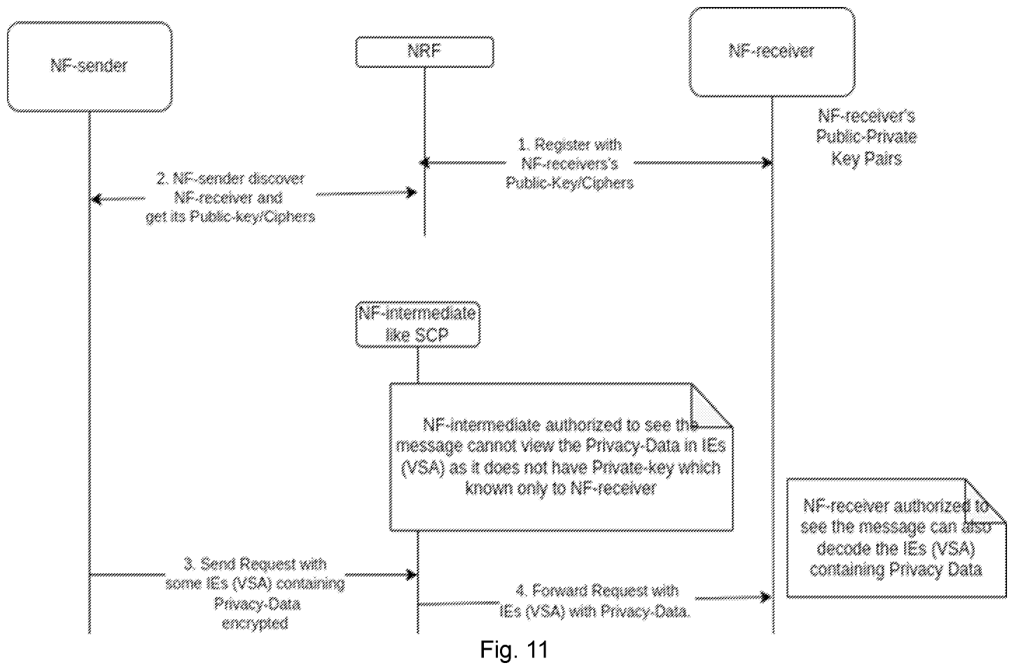

FIG. 11 shows a schematic diagram of signaling sequences according to example embodiments.

In a step 1 of FIG. 11, according to example embodiments, the NF-receiver/producer generates a public-private key pair (in case of asymmetric encryption). In case of symmetric encryption, the NF-receiver/producer may generate a “general” key (usable for encryption and decryption). When in the following a “first encryption key” is referred to, this is to mean the public key of the public-private key pair (in case of asymmetric encryption) or the “general” key (in case of symmetric encryption). Further, when in the following a “first decryption key” is referred to, this is to mean the private key of the public-private key pair (in case of asymmetric encryption) or the “general” key (in case of symmetric encryption, in this case, the “first encryption key” and the “first decryption key” are same). The NF-receiver/producer can publish its “first encryption key” (i.e., public key or general key) to a network repository function (NRF) while registering its NFProfile.

In a step 2 of FIG. 11, according to example embodiments, the NF-sender/consumer, before communicating to the NF-receiver/producer, discovers the NF-receiver/producer's NFProfile from the NRF. In the course thereof, the NF-sender/consumer also fetches the NF-receiver/producer's first encryption key.

In a step 3 of FIG. 11, according to example embodiments, the NF-sender/consumer encrypts the IEs or VSA containing some data (privacy data) using the NF-receivers/producer's first encryption key, and sends it to intermediate NFs. As the NF-sender/consumer is aware of that IE/VSA is privacy data, it will cipher the same while writing the logs. NF-sender/consumer may also include another IE/customer header indicating which IEs are encrypted in the message.

In a step 4 of FIG. 11, according to example embodiments, the NF-intermediate, though it can process the message, cannot decode the specific IE or VSA containing privacy information, as it is encrypted, such that it can be decoded only by the NF-receiver/producer (at least not by the NF-intermediate), as the NF-receiver/producer has the corresponding first decryption key. Hence, the NF-intermediate cannot write the logs with VSA/specific IE in clear text.

Example embodiments are specified below in more detail.

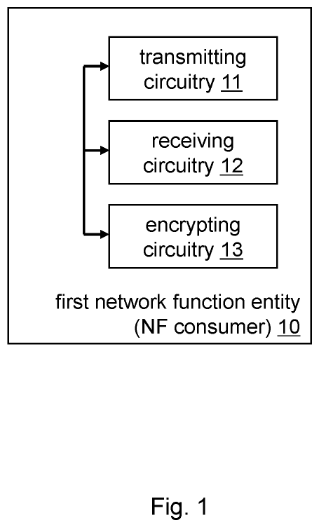

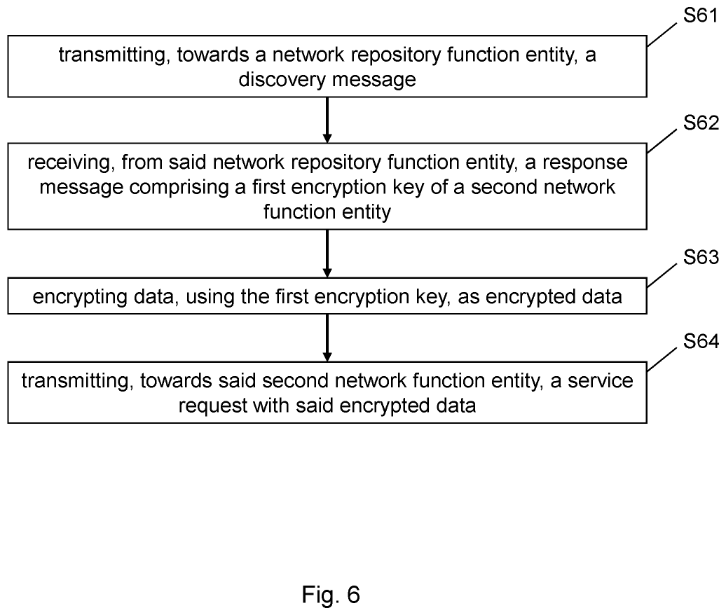

FIG. 1 is a block diagram illustrating an apparatus according to example embodiments. The apparatus may be a first network node or entity 10 such as an NF consumer entity (configured for communication with a second network function entity) comprising a transmitting circuitry 11, a receiving circuitry 12, and an encrypting circuitry 13. The transmitting circuitry 11 transmits, towards a network repository function entity, a discovery message. The receiving circuitry 12 receives, from said network repository function entity, a response message comprising a first encryption key of said second network function entity. The encrypting circuitry 13 encrypts data, using the first encryption key, as encrypted data. The transmitting circuitry 11 (or an additional transmitting circuitry) transmits, towards said second network function entity, a service request with said encrypted data. FIG. 6 is a schematic diagram of a procedure according to example embodiments. The apparatus according to FIG. 1 may perform the method of FIG. 6 but is not limited to this method. The method of FIG. 6 may be performed by the apparatus of FIG. 1 but is not limited to being performed by this apparatus.

As shown in FIG. 6, a procedure according to example embodiments comprises an operation of transmitting (S61), towards a network repository function entity, a discovery message, an operation of receiving (S62), from said network repository function entity, a response message comprising a first encryption key of said second network function entity, an operation of encrypting (S63) data, using the first encryption key, as encrypted data, and an operation of transmitting (S64), towards said second network function entity, a service request with said encrypted data.

The service request may comprise, besides the encrypted data, a header identifying the encrypted data.

In an embodiment at least some of the functionalities of the apparatus shown in FIG. 1 may be shared between two physically separate devices forming one operational entity. Therefore, the apparatus may be seen to depict the operational entity comprising one or more physically separate devices for executing at least some of the described processes.

According to further example embodiments, said response message includes a certificate related to said first encryption key.

According to further example embodiments, said encrypted data is at least one encrypted information element in said service request, wherein said service request includes header information identifying said at least one encrypted information element.

According to further example embodiments, said at least one encrypted information element includes vendor specific information and/or operator specific information. Optionally, said at least one encrypted information element includes any other information element available in the service request.

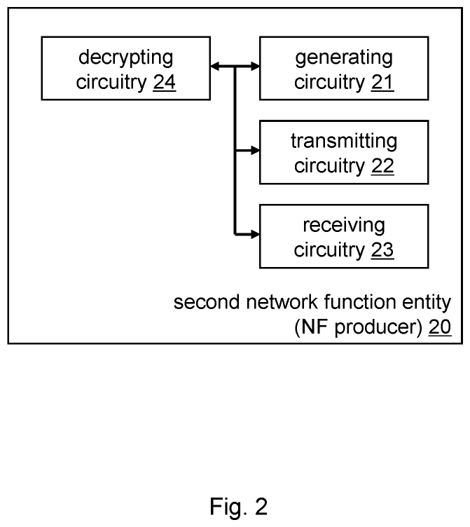

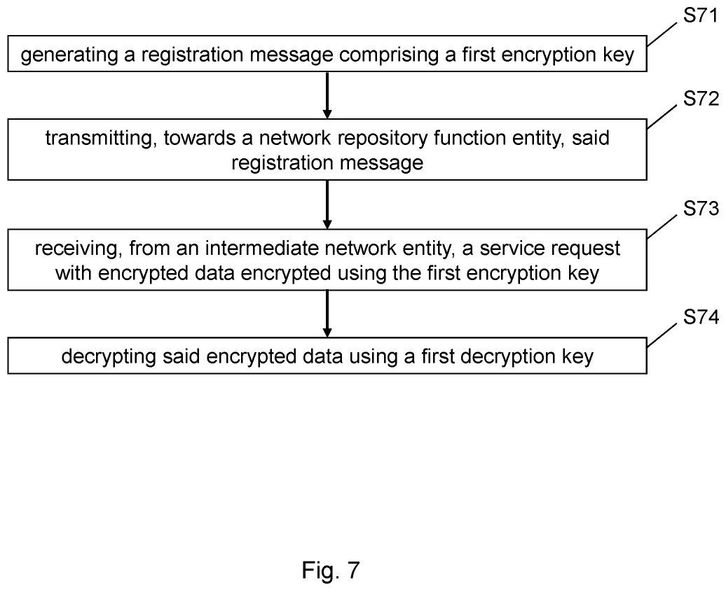

FIG. 2 is a block diagram illustrating an apparatus according to example embodiments. The apparatus may be a second network node or entity 20 such as an NF producer entity (configured for communication with a first network function entity) comprising a generating circuitry 21, a transmitting circuitry 22, a receiving circuitry 23, and a decrypting circuitry 24. The generating circuitry 21 generates a registration message comprising a first encryption key. The transmitting circuitry 22 transmits, towards a network repository function entity, said registration message. The receiving circuitry 23 receives, from an intermediate network entity, a service request with encrypted data encrypted using the first encryption key. The decrypting circuitry 24 decrypts said encrypted data using a first decryption key. FIG. 7 is a schematic diagram of a procedure according to example embodiments. The apparatus according to FIG. 2 may perform the method of FIG. 7 but is not limited to this method. The method of FIG. 7 may be performed by the apparatus of FIG. 2 but is not limited to being performed by this apparatus.

As shown in FIG. 7, a procedure according to example embodiments comprises an operation of generating (S71) a registration message comprising a first encryption key, an operation of transmitting (S72), towards a network repository function entity, said registration message, an operation of receiving (S73), from an intermediate network entity, a service request with encrypted data encrypted using the first encryption key, and an operation of decrypting (S74) said encrypted data using a first decryption key.

The service request may comprise, besides the encrypted data, a header identifying the encrypted data.

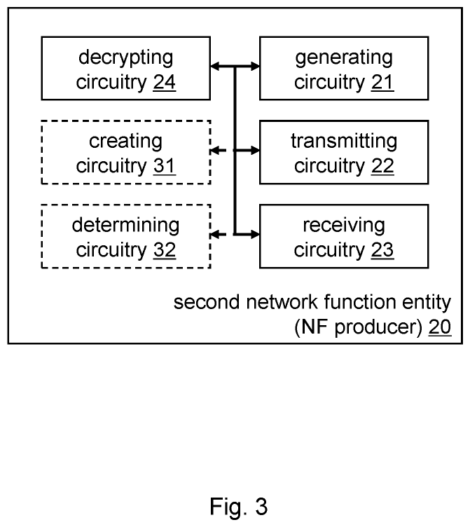

FIG. 3 is a block diagram illustrating an apparatus according to example embodiments. In particular, FIG. 3 illustrates a variation of the apparatus shown in FIG. 2. The apparatus according to FIG. 3 may thus further comprise a creating circuitry 31 and/or a determining circuitry 32.

In an embodiment at least some of the functionalities of the apparatus shown in FIG. 2 (or 3) may be shared between two physically separate devices forming one operational entity. Therefore, the apparatus may be seen to depict the operational entity comprising one or more physically separate devices for executing at least some of the described processes.

According to a variation of the procedure shown in FIG. 7, exemplary additional operations are given, which are inherently independent from each other as such. According to such variation, an exemplary method according to example embodiments may comprise an operation of creating said first encryption key, wherein said first encryption key equals said first decryption key. This particularly reflects the above-discussed symmetric encryption case.

Alternatively, according to a variation of the procedure shown in FIG. 7, exemplary additional operations are given, which are inherently independent from each other as such. According to such variation, an exemplary method according to example embodiments may comprise an operation of creating said first encryption key and said first decryption key. This particularly reflects the above-discussed asymmetric encryption case. Additionally, according to a further variation, an exemplary method according to example embodiments may comprise an operation of creating a certificate related to said first encryption key. Additionally, according to further example embodiments, said registration message includes said certificate.

According to further example embodiments, said encrypted data is at least one encrypted information element in said service request, wherein said service request includes header information identifying said at least one encrypted information element, and exemplary additional operations are given, which are inherently independent from each other as such, and exemplary details of the decrypting operation (S74) are given, which are inherently independent from each other as such. According to such variation, an exemplary method according to example embodiments may comprise an operation of determining said at least one encrypted information element using said header information. Further, such exemplary decrypting operation (S74) according to example embodiments may comprise an operation of decrypting said at least one encrypted information element utilizing said first decryption key.

According to further example embodiments, said at least one encrypted information element includes vendor specific information and/or operator specific information. Optionally, said at least one encrypted information element includes any other information element available in the service request.

Alternatively, according to a variation of the procedure shown in FIG. 7, exemplary additional operations are given, which are inherently independent from each other as such. According to such variation, an exemplary method according to example embodiments may comprise an operation of creating said first decryption key using a private key of a public-private key pair. Alternatively, said first decryption key may be a same symmetric key (i.e., same as the first encryption key).

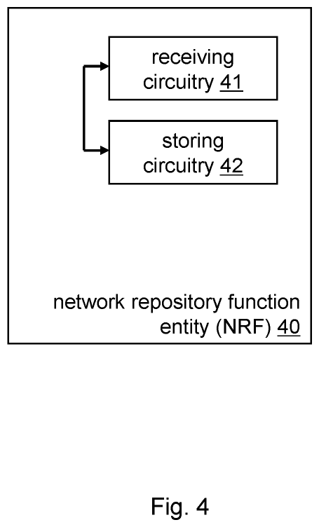

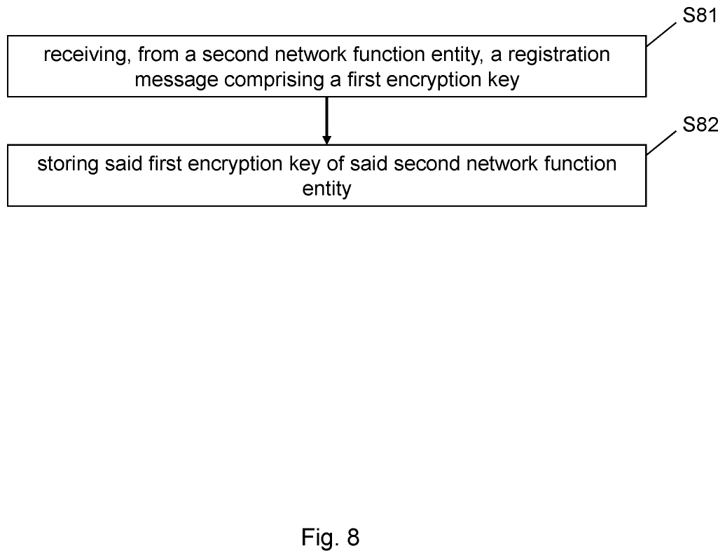

FIG. 4 is a block diagram illustrating an apparatus according to example embodiments. The apparatus may be a network repository function node or entity comprising a receiving circuitry 41 and a storing circuitry 42. The receiving circuitry 41 receives, from a second network function entity, a registration message comprising a first encryption key. The storing circuitry 42 stores said first encryption key of said second network function entity. FIG. 8 is a schematic diagram of a procedure according to example embodiments. The apparatus according to FIG. 4 may perform the method of FIG. 8 but is not limited to this method. The method of FIG. 8 may be performed by the apparatus of FIG. 4 but is not limited to being performed by this apparatus.

As shown in FIG. 8, a procedure according to example embodiments comprises an operation of receiving (S81), from a second network function entity, a registration message comprising a first encryption key, and an operation of storing (S82) said first encryption key of said second network function entity.

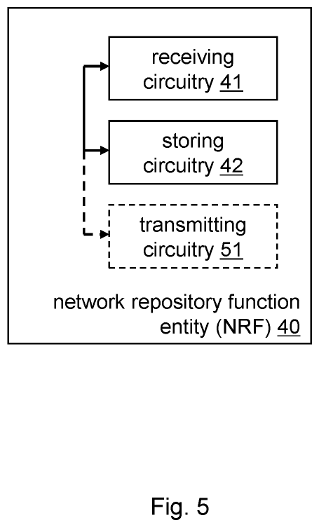

FIG. 5 is a block diagram illustrating an apparatus according to example embodiments. In particular, FIG. 5 illustrates a variation of the apparatus shown in FIG. 4. The apparatus according to FIG. 5 may thus further comprise a transmitting circuitry 51.

In an embodiment at least some of the functionalities of the apparatus shown in FIG. 4 (or 5) may be shared between two physically separate devices forming one operational entity. Therefore, the apparatus may be seen to depict the operational entity comprising one or more physically separate devices for executing at least some of the described processes.

According to a variation of the procedure shown in FIG. 8, exemplary additional operations are given, which are inherently independent from each other as such. According to such variation, an exemplary method according to example embodiments may comprise an operation of receiving, from a first network function entity, a discovery message, and an operation of transmitting, towards said first network function entity, a response message comprising said first encryption key of said second network function entity.

According to further example embodiments, said registration message includes a certificate related to said first encryption key.

Additionally, according to further example embodiments, said response message includes said certificate.

Example embodiments outlined and specified above are explained below in more specific terms.

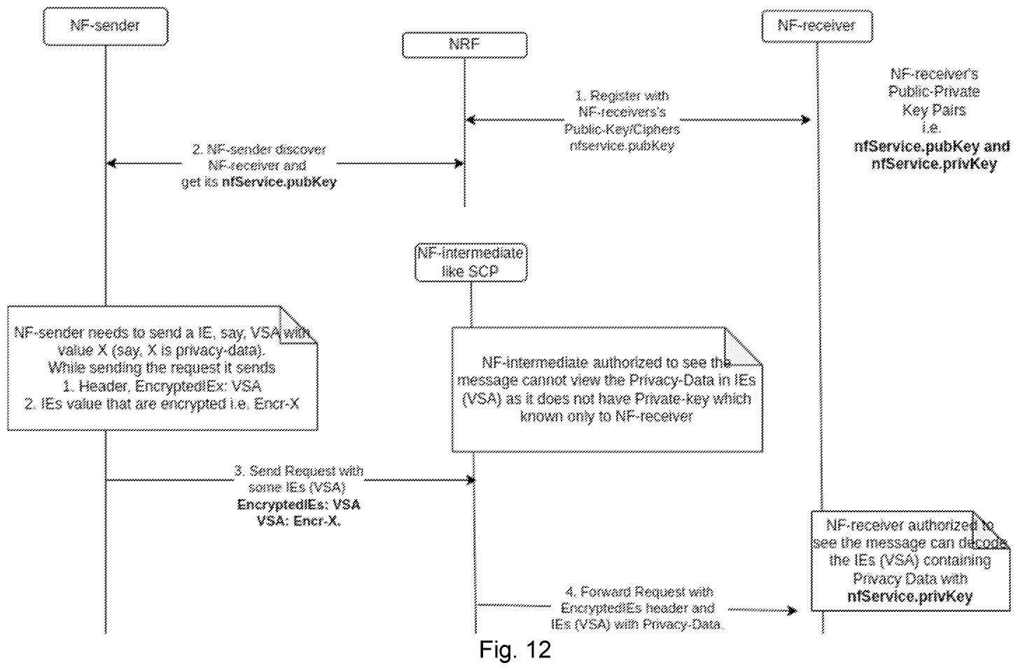

FIG. 12 shows a schematic diagram of signaling sequences according to example embodiments, and in particular illustrates a concrete scenario in which an NF-receiver/producer would generate an nfService.pubKey (first encryption key) and nfService.privKey (first decryption key) locally and publish only the nfService.pubKey (first encryption key) to the NRF along with its registration (step 1 of FIG. 12).

The NF Service registration may be structured as follows

NFService:
description: >
   Information of a given NF Service Instance; it is part of the NFProfile of an NF Instance
type: object
required:
   serviceInstanceId
properties:
   serviceInstanceId:
      type: string
   serviceName:
      $ref: ‘#/components/schemas/ServiceName’
   pubKey:
   type: string
      wherein, according to example embodiments, the sub-structure
pubKey:
   type: string
      being added to a possibly existing structure.

According to example embodiments, the NF-sender/consumer discovers the NF-receiver/producer to receive a message from the NRF. The NF-sender/consumer also gets the nfService.pubKey (first encryption key) details along with other required details (step 2 of FIG. 12).

According to example embodiments, the NF-sender/consumer, when sending some IEs (e.g., VSA) containing privacy-data (e.g., data “X”) that the NF-sender/consumer does not want other NFs like NF-intermediate to decode, encrypts the respective data (i.e., data “X”) with nfService.pubKey (first encryption key), resulting in e.g. “Encr-X”.

According to example embodiments, the NF-sender/consumer sends the following information in the message to the NF-receiver/producer (step 3 of FIG. 12) so that only the NF-receiver/producer can decode/decrypt:
a new header, e.g. “EncryptedIEs”, which contains the list of all IEs and/or attributes that are encrypted in the message,
all the IEs (pointed to in the header) in the request/message are encrypted with the first encryption key of the NF-receiver/producer.

The request/message may be structured as follows (both, VSA and a known IE like “mmeHost”, are covered)

```
{
  “title”: “NF-receiver service operation”,
  “required”: [
    “imsi”,
    “deregReason”
  ],
  “properties”: {
    “imsi”: {
      “description”: “IMSI”,
      “type”: “string”,
      “pattern”: “\hat{ }[0-9]{5,15}$”
    },
    “deregReason”: {
      “description”: “deregistration Reason”,
      “type”: “string”,
      “enum”: [
        “UE_INITIAL_AND_SINGLE_REGISTRATION”,
        “UE_INITIAL_AND_DUAL_REGISTRATION”,
        “EPS_TO_5GS_MOBILITY”
      ]
    },
    “vendorSpecific-051450”: {
      “$ref”: “#/definitions_element/VendorSpecific-051450”
    },
    “Encrypted-IEs”: {
      “type”: “string”
    },
  },
  “definitions_element”: {
          “ vendorSpecific-051450”: {
“description”: “This object lists all attributes that contain
Privacy-Data and only NF-receiver needs to decode”,
          “type”: “object”,
            “properties”: {
              “privacy-data-1”: {
                “type”: “string”
                },
            ...
              }
          }
    }
}
```

wherein, according to example embodiments, the sub-structures

```
  “vendorSpecific-051450”: {
    “$ref”: “#/definitions_element/VendorSpecific-051450”
  },
  “Encrypted-IEs”: {
    “type”: “string”
  },
and
      “ vendorSpecific-051450”: {
        “description”: “This object lists all attributes that contain
Privacy-Data and only NF-receiver needs to decode”,
        “type”: “object”,
        “properties”: {
          “privacy-data-1”: {
            “type”: “string”
            },
        ...
          }
      }
```

being added to a possibly existing structure.

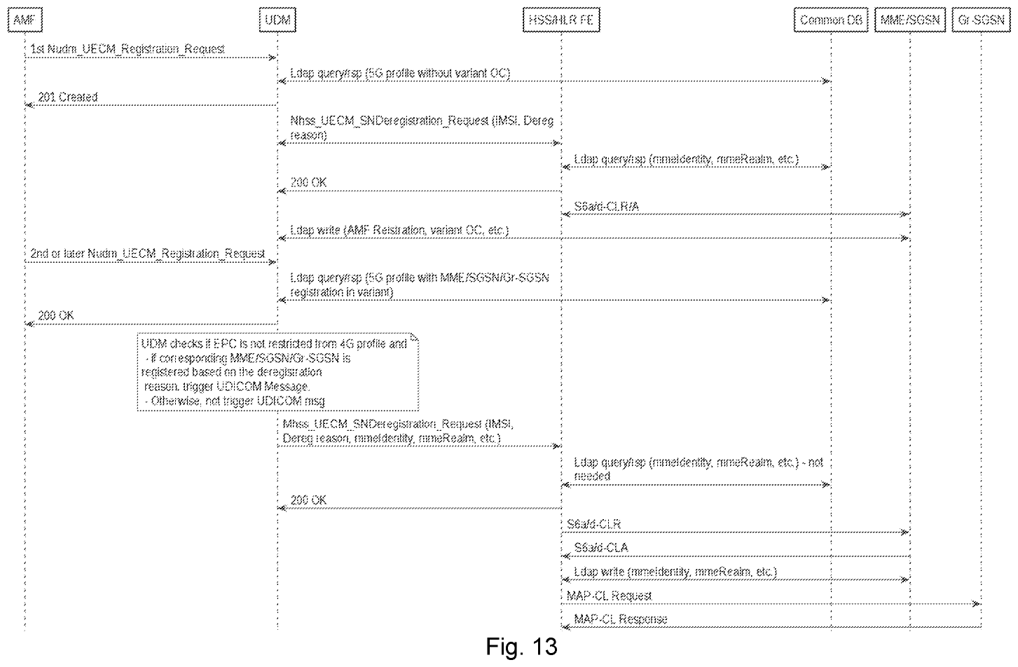

FIG. 13 shows a schematic diagram of signaling sequences according to example embodiments, and in particular illustrates a concrete scenario based on the scenario discussed above with reference to FIG. 10 (involving UDM, SCP and HSS), where the UDM sends a request to the HSS, i.e., invokes a Nhss_UECM_SNDeregistration service operation (TS 23.632), where transmission of e.g. mmeDetails as VSA may be desired.

For this use-case illustrated in FIG. 13, the Nhss_UECM_SNDeregistration request/message may be structured as follows

```
{
  “$schema”: “http://json-schema.org/draft-04/schema#”,
  “title”: “Nhss_UECM_SNDeregistrationReq”,
  “description”: “Nhss_UECM_SNDeregistration Service”,
  “type”: “object”,
  “required”: [
    “imsi”,
    “deregReason”
  ],
  “properties”: {
    “imsi”: {
      “description”: “IMSI”,
      “type”: “string”,
      “pattern”: “\hat{ }[0-9]{5,15}$”
    },
    “deregReason”: {
      “description”: “deregistration Reason”,
      “type”: “string”,
      “enum”: [
        “UE_INITIAL_AND_SINGLE_REGISTRATION”,
        “UE_INITIAL_AND_DUAL_REGISTRATION”,
        “EPS_TO_5GS_MOBILITY”
      ]
    },
    “vendorSpecific-051450”: {
      “$ref”: “#/definitions_element/VendorSpecific-051450”
    }
  },
  “definitions_element”: {
    “VendorSpecific-051450”: {
      “type”: “object”,
      “description”: “This object lists all \hat{ }vendor\hat{ } customized attributes”,
      “properties”: {
        “hssHlrRegExtension”: {
          “$ref”: “#/definitions_element/Proprietary-Data-1”
        }
      }
    },
    “Proprietary-Data-1”: {
      “type”: “object”,
      “description”: “This object lists all \hat{ }vendor\hat{ } customized attributes”,
      “required”: [
        “uidDn”,
        “hssAccessDetails”
      ],
      “properties”: {
        “uidDn”: {
          “description”: “ldap entry dn for uid of a subscriber”,
          “type”: “string”
        },
        “hssAccessDetails”: {
          “description”: “This object lists all attributes that could help HSS to
trigger Cancel-Location-Request without DB read”,
          “type”: “object”,
          “properties”: {
            “mmeIdentity”: {
              “$ref”: “#/definitions_element/DiameterIdentity”
            },
            “mmeHostID”: {
              “$ref”: “#/definitions_element/DiameterIdentity”
            },
            “mmeRealm”: {
              “$ref”: “#/definitions_element/DiameterIdentity”
            },
            “sgsnIdentity”: {
              “$ref”: “#/definitions_element/DiameterIdentity”
            },
            “sgsnRealm”: {
              “$ref”: “#/definitions_element/DiameterIdentity”
            },
            .
            .
            .
            }
          }
        }
      }
    }
}
```

wherein, according to example embodiments, the sub-structures

```
  “vendorSpecific-051450”: {
    “$ref”: “#/definitions_element/VendorSpecific-051450”
  }
and
  “VendorSpecific-051450”: {
    “type”: “object”,
    “description”: “This object lists all \hat{ }vendor\hat{ } customized attributes”,
    “properties”: {
      “hssHlrRegExtension”: {
        “$ref”: “#/definitions_element/Proprietary-Data-1”
      }
    }
  },
  “Proprietary-Data-1”: {
    “type”: “object”,
    “description”: “This object lists all \hat{ }vendor\hat{ } customized attributes”,
    “required”: [
      “uidDn”,
      “hssAccessDetails”
    ],
    “properties”: {
      “uidDn”: {
        “description”: “ldap entry dn for uid of a subscriber”,
        “type”: “string”
      },
      “hssAccessDetails”: {
        “description”: “This object lists all attributes that could help HSS to
trigger Cancel-Location-Request without DB read”,
        “type”: “object”,
        “properties”: {
          “mmeIdentity”: {
            “$ref”: “#/definitions_element/DiameterIdentity”
          },
          “mmeHostID”: {
            “$ref”: “#/definitions_element/DiameterIdentity”
          },
          “mmeRealm”: {
            “$ref”: “#/definitions_element/DiameterIdentity”
          },
          “sgsnIdentity”: {
            “$ref”: “#/definitions_element/DiameterIdentity”
          },
          “sgsnRealm”: {
            “$ref”: “#/definitions_element/DiameterIdentity”
          },
          .
          .
          .
        }
      }
    }
  }
```

being added to a possibly existing structure.

The above-described procedures and functions may be implemented by respective functional elements, processors, or the like, as described below.

In the foregoing exemplary description of the network entity, only the units that are relevant for understanding the principles of the disclosure have been described using functional blocks. The network entity may comprise further units that are necessary for its respective operation. However, a description of these units is omitted in this specification. The arrangement of the functional blocks of the devices is not construed to limit the disclosure, and the functions may be performed by one block or further split into sub-blocks.

When in the foregoing description it is stated that the apparatus, i.e. network node or entity (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

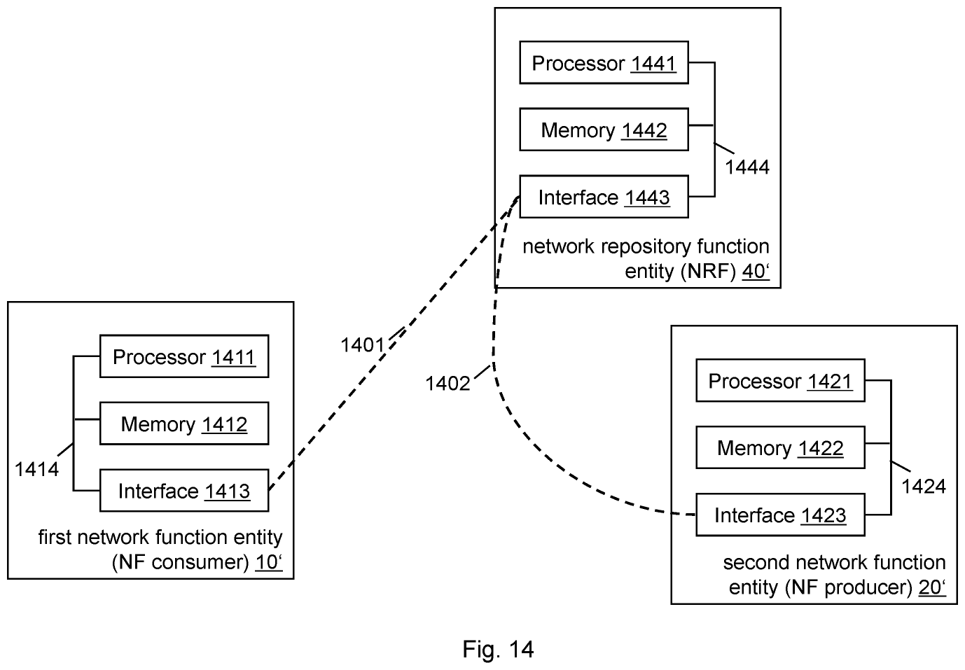

In FIG. 14, an alternative illustration of apparatuses according to example embodiments is depicted. As indicated in FIG. 14, according to example embodiments, the apparatus (first network function entity) 10′ (corresponding to the first network function entity 10) comprises a processor 1411, a memory 1412 and an interface 1413, which are connected by a bus 1414 or the like. Further, according to example embodiments, the apparatus (second network function entity) 20′ (corresponding to the second network function entity 20) comprises a processor 1421, a memory 1422 and an interface 1423, which are connected by a bus 1424 or the like. Further, according to example embodiments, the apparatus (network repository function entity) 40′ (corresponding to the network repository function entity 40) comprises a processor 1441, a memory 1442 and an interface 1443, which are connected by a bus 1444 or the like. The apparatuses may be connected via links 1401, 1402, respectively.

The processor 1411/1421/1441 and/or the interface 1413/1423/1443 may also include a modem or the like to facilitate communication over a (hardwire or wireless) link, respectively. The interface 1413/1423/1443 may include a suitable transceiver coupled to one or more antennas or communication means for (hardwire or wireless) communications with the linked or connected device(s), respectively. The interface 1413/1423/1443 is generally configured to communicate with at least one other apparatus, i.e. the interface thereof.

The memory 1412/1422/1442 may store respective programs assumed to include program instructions or computer program code that, when executed by the respective processor, enables the respective electronic device or apparatus to operate in accordance with the example embodiments.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to example embodiments, an apparatus representing the first network function entity 10 (configured for communication with a second network function entity) comprises at least one processor 1411, at least one memory 1412 including computer program code, and at least one interface 1413 configured for communication with at least another apparatus. The processor (i.e. the at least one processor 1411, with the at least one memory 1412 and the computer program code) is configured to perform transmitting, towards a network repository function entity, a discovery message (thus the apparatus comprising corresponding means for transmitting), to perform receiving, from said network repository function entity, a response message comprising a first encryption key of said second network function entity (thus the apparatus comprising corresponding means for receiving), to perform encrypting data, using the first encryption key, as encrypted data (thus the apparatus comprising corresponding means for encrypting), and to perform transmitting, towards said second network function entity, a service request with said encrypted data.

According to example embodiments, an apparatus representing the second network function entity 20 (configured for communication with a first network function entity) comprises at least one processor 1421, at least one memory 1422 including computer program code, and at least one interface 1423 configured for communication with at least another apparatus. The processor (i.e. the at least one processor 1421, with the at least one memory 1422 and the computer program code) is configured to perform generating a registration message comprising a first encryption key (thus the apparatus comprising corresponding means for generating), to perform transmitting, towards a network repository function entity, said registration message (thus the apparatus comprising corresponding means for transmitting), to perform receiving, from an intermediate network entity, a service request with encrypted data encrypted using the first encryption key (thus the apparatus comprising corresponding means for receiving), and to perform decrypting said encrypted data using a first decryption key (thus the apparatus comprising corresponding means for decrypting).

According to example embodiments, an apparatus representing the network repository function entity 40 comprises at least one processor 1441, at least one memory 1442 including computer program code, and at least one interface 1443 configured for communication with at least another apparatus. The processor (i.e. the at least one processor 1441, with the at least one memory 1442 and the computer program code) is configured to perform receiving, from a second network function entity, a registration message comprising a first encryption key (thus the apparatus comprising corresponding means for receiving), and to perform storing said first encryption key of said second network function entity (thus the apparatus comprising corresponding means for storing).

For further details regarding the operability/functionality of the individual apparatuses, reference is made to the above description in connection with any one of FIGS. 1 to 13, respectively.

For the purpose of the present disclosure as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present disclosure. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

In view of the above, there are provided measures for data minimization in network function to network function communication. Such measures exemplarily comprise, at a first network function entity configured for communication with a second network function entity, transmitting, towards a network repository function entity, a discovery message, receiving, from said network repository function entity, a response message comprising a first encryption key of said second network function entity, encrypting data, using the first encryption key, as encrypted data, and transmitting, towards said second network function entity, a service request with said encrypted data.

Even though the disclosure is described above with reference to the examples according to the accompanying drawings, it is to be understood that the disclosure is not restricted thereto. Rather, it is apparent to those skilled in the art that the present disclosure can be modified in many ways without departing from the scope of the inventive idea as disclosed herein.

List of acronyms and abbreviations
3GPP 3rd Generation Partnership
4G 4th Generation
5G 5th Generation
AF application function
AMF access and mobility management function
API application programming interface
HSS home subscriber server
HTTP/2 Hypertext Transfer Protocol Version 2
IE information element
IMEI International Mobile Equipment Identity
JSON JavaScript Object Notation
NEF network exposure function
NF network function
NRF network repository function
PEAP privacy assurance and engineering process
PLMN public land mobile network
SBI service-based interface
SCP service communication proxy
SEPP security edge protection proxy
SMF session management function
TLS transport layer security
UDM unified data manager, unified data management services
UDR unified data repository
VSA vendor-specific attributes

I/We claim:

1. An apparatus of a first network function entity configured for communication with a second network function entity, the apparatus comprising
at least one processor,
at least one memory including computer program code, and
at least one interface configured for communication with at least another apparatus,
the at least one processor, with the at least one memory and the computer program code, being configured to cause the apparatus to perform:
transmitting, towards a network repository function entity, a discovery message,
receiving, from said network repository function entity, a response message comprising a first encryption key of said second network function entity,
encrypting data, using the first encryption key, as encrypted data, and
transmitting, towards said second network function entity, a service request with said encrypted data.

2. The apparatus according to claim 1, wherein
said response message comprises a certificate related to said first encryption key.

3. The apparatus according to claim 1, wherein
said encrypted data is at least one encrypted information element in said service request, wherein said service request comprises header information identifying said at least one encrypted information element.

4. The apparatus according to claim 3, wherein
said at least one encrypted information element comprises vendor specific information and/or operator specific information.

5. An apparatus of a second network function entity configured for communication with a first network function entity, the apparatus comprising
at least one processor,
at least one memory including computer program code, and
at least one interface configured for communication with at least another apparatus,
the at least one processor, with the at least one memory and the computer program code, being configured to cause the apparatus to perform:
generating a registration message comprising a first encryption key,
transmitting, towards a network repository function entity, said registration message,
receiving, from an intermediate network entity, a service request with encrypted data encrypted using the first encryption key, and
decrypting said encrypted data using a first decryption key.

6. The apparatus according to claim 5, wherein
the at least one processor, with the at least one memory and the computer program code, being configured to cause the apparatus to perform:
creating said first encryption key, wherein said first encryption key equals said first decryption key, or
creating said first encryption key and said first decryption key, and optionally a certificate related to said first encryption key, wherein optionally said registration message comprises said certificate.

7. The apparatus according to claim 5, wherein
said encrypted data is at least one encrypted information element in said service request, wherein said service request comprises header information identifying said at least one encrypted information element, and wherein the at least one processor, with the at least one memory and the computer program code, being configured to cause the apparatus to perform:
determining said at least one encrypted information element using said header information, and
in relation to said decrypting, the at least one processor, with the at least one memory and the computer program code, being configured to cause the apparatus to perform:
decrypting said at least one encrypted information element utilizing said first decryption key.

8. The apparatus according to claim 7, wherein
said at least one encrypted information element comprises vendor specific information and/or operator specific information.

9. An apparatus, the apparatus comprising
at least one processor,
at least one memory including computer program code, and
at least one interface configured for communication with at least another apparatus,
the at least one processor, with the at least one memory and the computer program code, being configured to cause the apparatus to perform:
receiving, from a second network function entity, a registration message comprising a first encryption key, and
storing said first encryption key of said second network function entity.

10. The apparatus according to claim 9, wherein
the at least one processor, with the at least one memory and the computer program code, being configured to cause the apparatus to perform:
receiving, from a first network function entity, a discovery message, and
transmitting, towards said first network function entity, a response message comprising said first encryption key of said second network function entity.

11. The apparatus according to claim 10, wherein
said response message comprises said certificate.

12. The apparatus according to claim 9, wherein
said registration message comprises a certificate related to said first encryption key.
